(19) United States
(12) Patent Application Publication
(10) Pub. No.: US 2016/0297155 A1
(43) Pub. Date: Oct. 13, 2016

(54) Methods for Manufacturing Articles Comprising Photochromic Film

(71) Applicant: Angel 7 Industries, LLC, San Antonio, TX (US)

(72) Inventor: Kerry S. Harris, San Antonio, TX (US)

(21) Appl. No.: 14/681,261

(22) Filed: Apr. 8, 2015

(51) Int. Cl. B29D 11/00; B29C 45/14

(52) U.S. Cl. CPC B29D 11/0074; B29C 45/14811

(57) ABSTRACT

The present invention relates to methods of manufacturing articles comprising photochromic film, such as eyeshields, faceshields and lenses. Specifically, the methods of the present invention apply photochromic material to optically transparent thermoplastic material. Preferably, photochromic material is adhered to optically transparent thermoplastic material, such as polycarbonate, in a hot molding process.

### TECHNICAL FIELD

The present invention relates to methods of manufacturing articles comprising photochromic film, such as eyeshields, faceshields and lenses. Specifically, the methods of the present invention apply photochromic material to optically transparent material. Preferably, photochromic material is adhered to optically transparent material in a hot molding process.

### BACKGROUND

Optically transparent material may have a variety of uses. For example, eyeshields, faceshields and lenses are, of course, generally known optically transparent materials that may provide useful functions to wearers of the same. Specifically, lenses may be utilized in eyeglasses to help correct vision, for example. Indeed, eyeshields, faceshields and lenses may also provide the alternative or additional benefit of protecting a user's eyes or face from harm, which may come from physical sources, such as impacts from ballistics, explosions, or other like sources or harm, or from unseen sources, such as from radiation from the sun.

Indeed, eyeshields, faceshields and lenses are commonly used in helmets, such as sports helmets, motorcycle helmets, goggles, bicycle face shields, protective eyewear, and other like apparatuses. Eyeshields, faceshields and lenses may simply comprise a layer of plastic held in place over a user's eyes and/or face. Thus, the eyeshields, faceshields and lenses operate to protect a user's eyes and face from debris or other like airborne material.

Likewise, eyeshields, faceshields and lenses may be in the form of glasses or other protective eyewear that may aid a user's vision and/or protect the user from harmful radiation, such as from the sun or other sources. Commonly, sunglasses are used by individuals to decrease the amount of visible or invisible radiation from entering a user's eyes. For example, in many cases, user's wear sunglasses to combat the brightness of the sun or from other like sources. In addition, user's wear sunglasses for protecting against harmful ultraviolet radiation from the sun or other like sources.

Often, users of eyeshields, faceshields and lenses must move from areas of brightness to areas of relative darkness. Indeed, in many cases members of the military or police force must traverse between areas of high brightness, such as outside under the bright sun, and inside, such as in buildings and the like rapidly. To protect a user's eyes in such a situation, photochromic film may be used.

Photochromic film or photochromic material darkens upon exposure to certain types of light, such as ultraviolet light. Common photochromic materials utilize a transparent substrate, such as glass or plastic, having embedded therein or coated thereon silver halide particles or molecules. Silver chloride molecules are most commonly used as photochromic material. Upon exposure to ultraviolet light, for example, the photochromic materials absorb the radiation and darken, which subsequently blocks the transmission of visible and invisible light through the substrate. Removal from the ultraviolet light subsequently causes the photochromic material to lighten, allowing more light to pass therethrough. Thus, photochromic material, such as film, is used on eyeshields, faceshields and lenses where a user may traverse outside to inside, and vice versa.

Typically, photochromic material is added to transparent substrates by “flow coating” the photochromic material onto the surface of the eyeshields, faceshields and/or lenses. Specifically, the eyeshield, faceshield or lens is manufactured, and the photochromic material is disposed over the surface of the eyeshield or lens and then baked on.

The flow coating method, however, suffers from serious drawbacks. Specifically, the bond between the photochromic material and the transparent substrate is typically fairly weak, and the photochromic material may become scratched or otherwise removed from the substrate material fairly easily. Moreover, the photochromic material may not be embedded within a substrate and as such may simply sit on the outside surface of the eyeshield, faceshield or lens, which may also contribute to the ease of scratching or otherwise removing the photochromic material from the surface of the eyeshield, faceshield or lens.

A need, therefore, exists for an eyeshield, faceshield or lens having a resilient photochromic material incorporated therewith. Specifically, a need exists for an eyeshield, faceshield or lens where the photochromic material may be protected and provide its functional use thereon.

Moreover, a need exists for an eyeshield, faceshield or lens made by a process that more securely holds the photochromic material on or in a substrate. More specifically, a need exists for an eyeshield, faceshield or lens made by a process where the photochromic material may be embedded within a film that may be tightly adhered to a transparent substrate.

Further, a need exists for an eyeshield, faceshield or lens made by a process that is quicker and less costly than heretofore known methods. Still further, a need exists for an eyeshield, faceshield or lens that may be utilized in many applications, such as in motorcycle helmets and faceshields, bicycle faceshields and lenses, military lenses and faceshields, law enforcement face shields and lenses, pilot faceshields, sports glasses, safety glasses, industrial faceshields, and other like applications.

### SUMMARY OF THE INVENTION

The present invention relates to methods of manufacturing articles comprising photochromic film, such as eyeshields, faceshields and lenses. Specifically, the methods of the present invention apply photochromic material to optically transparent material. Preferably, photochromic material is adhered to optically transparent material in a hot molding process.

To this end, in an embodiment of the present invention, a method of making an article is provided, the method comprises the steps of: providing a mold having an internal surface; placing an amount of photochromic film within the mold on the internal surface; closing the mold so that the photochromic film is disposed within the mold on the internal surface injecting melted material into the mold to form a shaped article; and cooling the shaped article, wherein the shaped article comprises a photochromic film bonded thereto.

In an embodiment, the method further comprises the step of cutting the shaped article into a final shape.

In an embodiment, the photochromic film comprises photochromic particles embedded therein.

In an embodiment, the photochromic film comprises an optically transparent film having a first surface and a second surface, and photochromic particles coated to the first surface of the optically transparent film.

In an embodiment, the photochromic film is placed within the mold such that the second surface contacts the internal surface of the mold and the first surface coated with photochromic particles contacts the melted material when injected into the mold.

In an embodiment, the photochromic film takes on the shape of the internal surface of the mold prior to injecting with melted material.

In an embodiment, the melted material is selected from the group consisting of a thermoplastic material, a thermoset material and glass.

In an embodiment, the melted material is a thermoplastic material selected from the group consisting of polycarbonate, polyacrylic, polyurethane, polyvinyl acetate, polyvinyl chloride, polyvinylidene chloride, polyethylene, polypropylene and combinations thereof.

In an embodiment, the melted material is polycarbonate.

In an embodiment, the shaped article is optically transparent when cooled.

In an embodiment, the method further comprises the step of: cutting photochromic film to form the amount of photochromic film prior to placing the amount of photochromic film in the mold.

In an embodiment, the method further comprises the step of sizing the photochromic film and cutting the photochromic film to form the amount of photochromic film such that the amount of photochromic film is roughly the size of the shaped article prior to placing the amount of photochromic film into the mold.

In an embodiment, the method further comprises the step of sizing the photochromic film and cutting the photochromic film to form the amount of photochromic film such that the amount of photochromic is roughly the size of the final shape of the article prior to placing the amount of photochromic film into the mold.

In an embodiment, the shaped article is selected from the group consisting of an eyeshield, a faceshield, and a lens.

In an embodiment, the final shape is selected from the group consisting of an eyeshield, a faceshield, and a lens.

In an embodiment, the present invention comprises a shaped article.

In an embodiment, the photochromic film is bonded to a surface of the shaped article.

In an embodiment, the shaped article is selected from the group consisting of an eyeshield, a faceshield, and a lens.

In an embodiment, the photochromic particles are disposed between the film and the melted material.

In an embodiment, the photochromic particles are in a layer between the optically transparent film and the melted material.

It is, therefore, an advantage and objective of the present invention to provide an eyeshield, faceshield or lens having a resilient photochromic material incorporated therewith.

Specifically, it is an advantage and objective of the present invention to provide an eyeshield, faceshield or lens where the photochromic material may be protected and provide its functional use thereon.

Moreover, it is an advantage and objective of the present invention to provide an eyeshield, faceshield or lens made by a process that more securely holds the photochromic material on or in a substrate.

More specifically, it is an advantage and objective of the present invention to provide an eyeshield, faceshield or lens made by a process where the photochromic material may be embedded within a film that may be tightly adhered to a transparent substrate.

Further, it is an advantage and objective of the present invention to provide an eyeshield, faceshield or lens made by a process that is quicker and less costly than heretofore known methods.

Still further, it is an advantage and objective of the present invention to provide an eyeshield, faceshield or lens that may be utilized in many applications, such as in motorcycle helmets and faceshields, bicycle faceshields and lenses, military lenses and faceshields, law enforcement face shields and lenses, pilot faceshields, sports glasses, safety glasses, industrial faceshields, and other like applications.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a method of bonding photochromic film to a transparent thermoplastic substrate having a circular shape in an embodiment of the present invention.

FIG. 2 illustrates an article having a photochromic film bonded thereto in an embodiment of the present invention.

FIG. 3 illustrates a method of bonding photochromic film to a thermoplastic substrate having a spherical shape in an embodiment of the present invention.

FIG. 4 illustrates a method of bonding photochromic film to a thermoplastic substrate having a cylindrical shape in an embodiment of the present invention.

FIG. 5 illustrates a method of bonding photochromic film to a thermoplastic substrate having an irregular shape in an embodiment of the present invention.

### DETAILED DESCRIPTION OF THE PRESENTLY PREFERRED EMBODIMENTS

The present invention relates to methods of manufacturing articles comprising photochromic film, such as eyeshields, faceshields and lenses. Specifically, the methods of the present invention apply photochromic material to optically transparent material. Preferably, photochromic material is adhered to optically transparent material in a hot molding process.

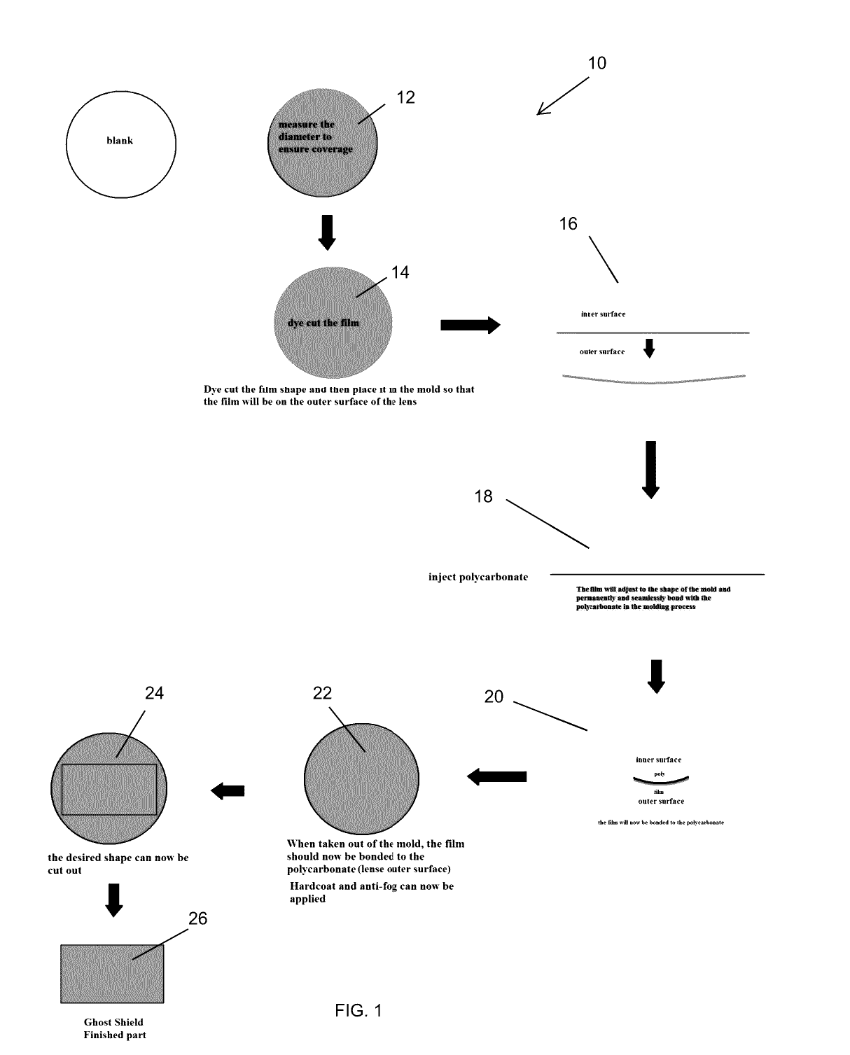

Now referring to the figures, wherein like numerals refer to like parts, FIG. 1 illustrates a method 10 for bonding photochromic film to a transparent thermoplastic or thermoset substrate having a circular shape. The method 10 comprises a first step of measuring the shape and size of photochromic film necessary to provide full coverage of the transparent substrate. The photochromic film may be any film having photochromic material therein, such as a transparent thermoplastic film having photochromic particles embedded therein. Any resilient transparent thermoplastic or thermoset material may be utilized for the photochromic film. Specifically, the thermoplastic or thermoset material should be resilient to survive the hot-molding process, as disclosed below. Moreover, the photochromic film may be bendable or flexible to take the shape of the desired eyeshield, faceshield or lens, as described below.

The optically transparent substrate to which the photochromic film is bonded may be any thermoplastic material known to one of ordinary skill in the art that may be useful for receiving the photochromic film, as disclosed herein. Exemplary transparent thermoplastic substrates may include, but may not be limited to, polycarbonate, polyacrylic, polyurethane, polyvinyl acetate, polyvinyl chloride, polyvinylidene chloride, polyethylene, polypropylene, combinations thereof or any other like transparent thermoplastic material. Alternately, the optically transparent substrate may be made of any other rigid transparent material, such as glass, as apparent to one of ordinary skill in the art.

The photochromic particles may be made from any photochromic material apparent to one of ordinary skill in the art. Commonly, silver halide particles, such as silver chloride particles, are utilized as photochromic material that may be embedded in transparent thermoplastic or thermoset film to form the photochromic film. Alternatively, the photochromic particles may be embedded within a thin layer of glass. Alternatively, the photochromic material may be coated to a transparent thermoplastic or thermoset film or glass.

Specifically, the photochromic film, in a first step 12, may be sized against a blank to ensure that the photochromic film is sufficiently sized. In a second step 14, the photochromic film may be cut via any known method, such as die cut, to form the desired size and shape. In a third step 16, the die cut film may be placed within a mold, and the photochromic film may be oriented to ensure that the desired surfaces face the proper direction. For example, it may be desired that one surface of the photochromic film face inwardly as the bonding surface to the transparent thermoplastic material bonded thereto. Specifically, if the photochromic material is coated onto the transparent thermoplastic or thermoset film, then the surface having the photochromic material coated thereon may be the bonding surface for the transparent thermoplastic substrate. This may ensure that the photochromic material is not exposed to be scratched or otherwise removed from the film.

After the photochromic film is placed in a mold and the mold is closed upon the film, the film will generally take the shape of the mold due its bendability and resiliency. In a fourth step 18, melted material may be injected into the mold, such as melted thermoplastic material. Preferably, hot melted polycarbonate thermoplastic material may be injected into the mold to form an article when cooled. When cooled in a fifth step 20, the article may thus have the photochromic film securely bonded thereto, and taking the shape of the article. In a sixth step 22, the article may be taken out of the mold and other coatings may be applied to the article, such as, for example, hardcoat and/or anti-fog coatings, as desired.

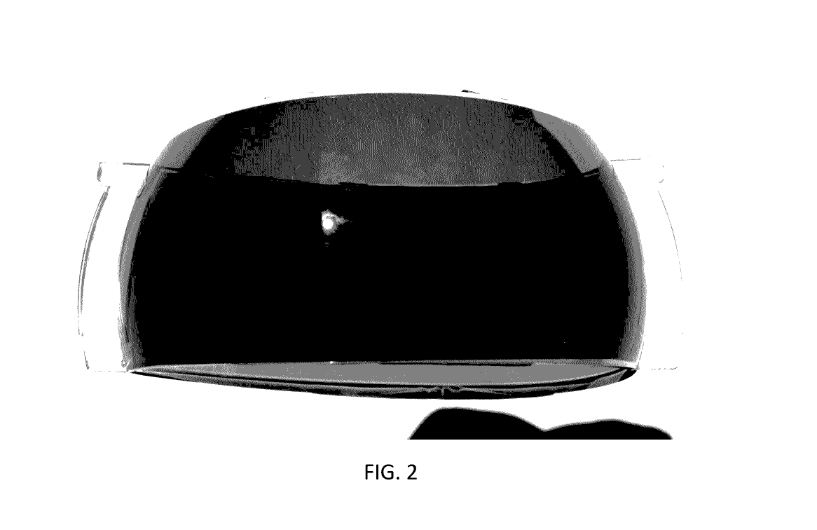

In a seventh step 24, the article may be cut into the desired final shape and utilized in a finished part, as shown in eighth step 26. For example, FIG. 2 illustrates a finished article having a photochromic material bonded thereto in the process specified above.

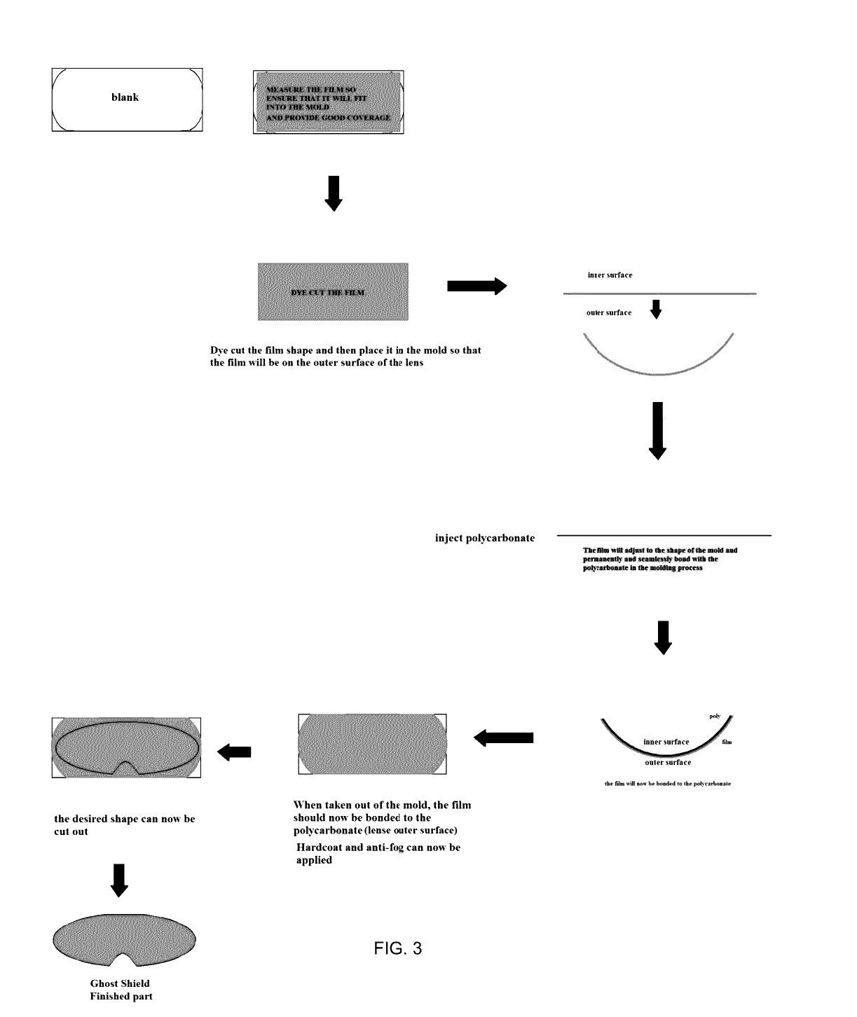

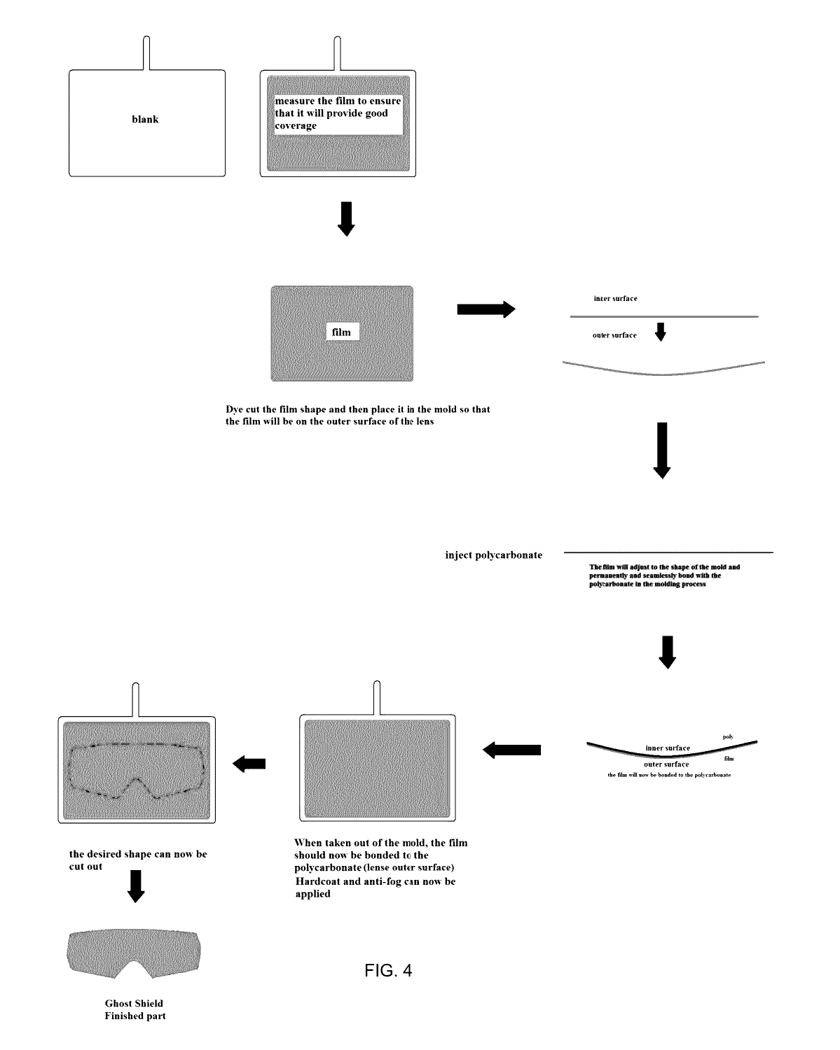

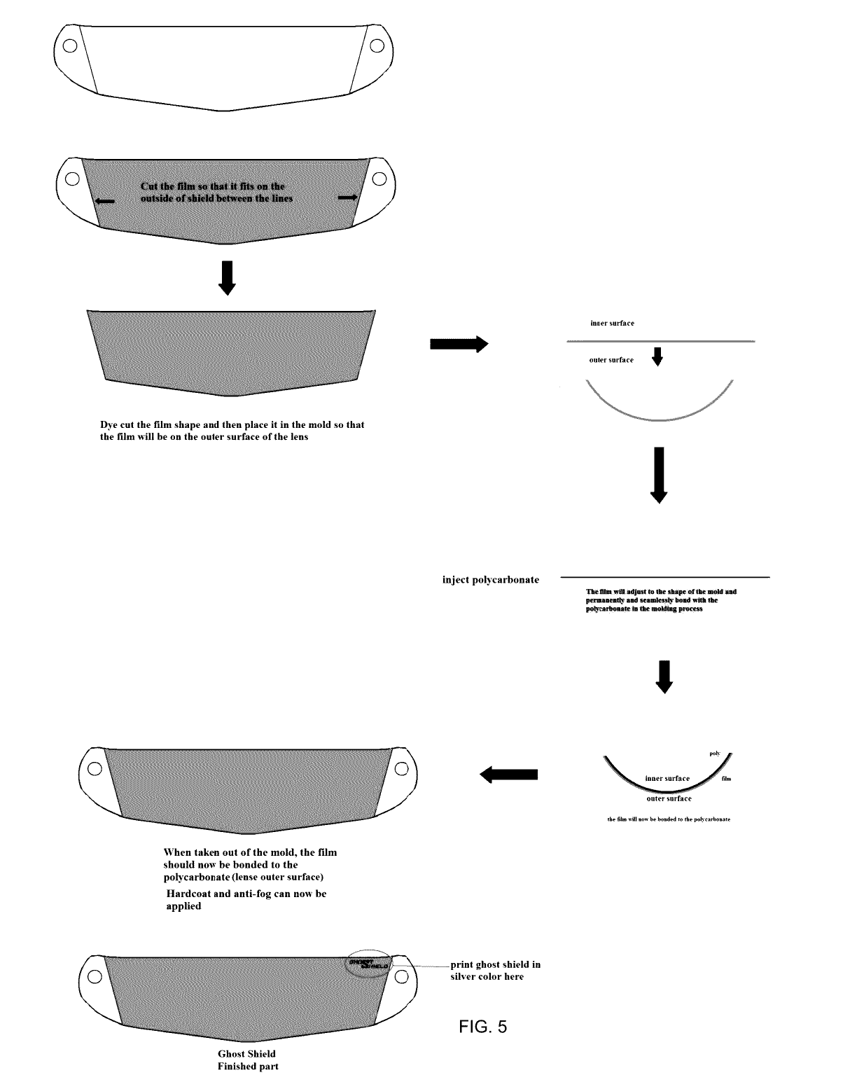

FIGS. 3-5 illustrate methods for making several other shaped articles, such as spherically-shaped articles (FIG. 3), cylindrically-shaped articles (FIG. 4), and irregularly-shaped articles (FIG. 5). Of course, it should be noted that the present methodology may be utilized to bond photochromic film to any shaped article that may be made in a hot mold process, and the invention should not be limited as described herein.

As provided herein, eyeshields, faceshields and lenses may be made using the methodology as described above. Of course, these eyeshields, faceshields and lenses may have a plurality of applications, including as motorcycle faceshields and helmet lenses, bicycle faceshields and lenses, in military faceshields and lenses, pilot faceshields, law enforcement faceshields and lenses, auto sports faceshields, such as helmets used in auto racing, sports sunglasses, safety glasses, aviation faceshields and lenses, and in industrial and commercial faceshields and lenses, although the present invention should not be limited as described herein.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A method of making an article comprising the steps of:
providing a mold having an internal surface;
placing an amount of photochromic film within the mold on the internal surface;
closing the mold so that the photochromic film is disposed within the mold on the internal surface
injecting melted material into the mold to form a shaped article; and
cooling the shaped article, wherein the shaped article comprises a photochromic film bonded thereto.

2. The method of claim 1 further comprising the step of:
cutting the shaped article into a final shape.

3. The method of claim 1 wherein the photochromic film comprises photochromic particles embedded therein.

4. The method of claim 1 wherein the photochromic film comprises an optically transparent film having a first surface and a second surface, and photochromic particles coated to the first surface of the optically transparent film.

5. The method of claim 4 wherein the photochromic film is placed within the mold such that the second surface contacts the internal surface of the mold and the first surface coated with photochromic particles contacts the melted material when injected into the mold.

6. The method of claim 1 wherein the photochromic film takes on the shape of the internal surface of the mold prior to injecting with melted material.

7. The method of claim 1 wherein the melted material is selected from the group consisting of a thermoplastic material, a thermoset material and glass.

8. The method of claim 1 wherein the melted material is a thermoplastic material selected from the group consisting of polycarbonate, polyacrylic, polyurethane, polyvinyl acetate, polyvinyl chloride, polyvinylidene chloride, polyethylene, polypropylene and combinations thereof.

9. The method of claim 8 wherein the melted material is polycarbonate.

10. The method of claim 1 wherein the shaped article is optically transparent when cooled.

11. The method of claim 1 further comprising the step of:
cutting photochromic film to form the amount of photochromic film prior to placing the amount of photochromic film in the mold.

12. The method of the claim 1 further comprising the step of:
sizing the photochromic film and cutting the photochromic film to form the amount of photochromic film such that the amount of photochromic film is roughly the size of the shaped article prior to placing the amount of photochromic film into the mold.

13. The method of claim 2 further comprising the step of:
sizing the photochromic film and cutting the photochromic film to form the amount of photochromic film such that the amount of photochromic is roughly the size of the final shape of the article prior to placing the amount of photochromic film into the mold.

14. The method of claim 1 wherein the shaped article is selected from the group consisting of an eyeshield, a faceshield, and a lens.

15. The method of clam 2 wherein the final shape is selected from the group consisting of an eyeshield, a faceshield, and a lens.

16. A shaped article made by the method of claim 1.

17. The shaped article of claim 16 wherein the photochromic film is bonded to a surface of the shaped article.

18. The shaped article of claim 16, wherein the shaped article is selected from the group consisting of an eyeshield, a faceshield, and a lens.

19. A shaped article made by the method of claim 5, wherein the photochromic particles are disposed between the film and the melted material.

20. The shaped article of claim 19 wherein the photochromic particles are in a layer between the optically transparent film and the melted material.
